(19) United States
(12) Patent Application Publication
(10) Pub. No.: US 2015/0039925 A1
(43) Pub. Date: Feb. 5, 2015

(54) COMPUTING DEVICE AND METHOD FOR ADJUSTING AN OPERATING STATUS OF A COMPUTING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/445,326

(22) Filed: Jul. 29, 2014

(30) Foreign Application Priority Data
Jul. 30, 2013 (TW) 102127277

(51) Int. Cl. G06F 1/32; G06F 1/26

(52) U.S. Cl. CPC G06F 1/3212; G06F 1/263
USPC 713/323

(57) ABSTRACT

The computing device calculates a battery level of a battery of the computing device when the computing device is powered by direct current (DC) electricity of the battery. The computing device adjusts an operating system (OS) of the computing device to a sleep mode when the battery is in a warming state. The computing device activates a watchdog (WDT) of a basic input output system (BIOS) to count a predetermined time and saves data into the storage device before the predetermined time ends.

### CROSS-REFERENCE TO RELATED APPLICATIONS

This application claims priority to Taiwanese Patent Application No. 102127277 filed on Jul. 30, 2013 in the Taiwan Intellectual Property Office, the contents of which are incorporated by reference herein.

### FIELD

Embodiments of the present disclosure relate to a simulation technology, and particularly to a computing device and a method for adjusting an operating status of a computing device.

### BACKGROUND

A computing device (for example, an all-in-one computer) is usually powered by electricity of a power supply. However, if the computing device is disconnected to the power supply, the computing device can be shut down.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a computing device.

FIG. 2 is a flowchart of an example embodiment of a method for adjusting an operating status of a computing device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY^{TM}, flash memory, and hard disk drives. The term “comprising” means “including, but not necessarily limited to”; it specifically indicates open-ended inclusion or membership in a so-described combination, group, series and the like.

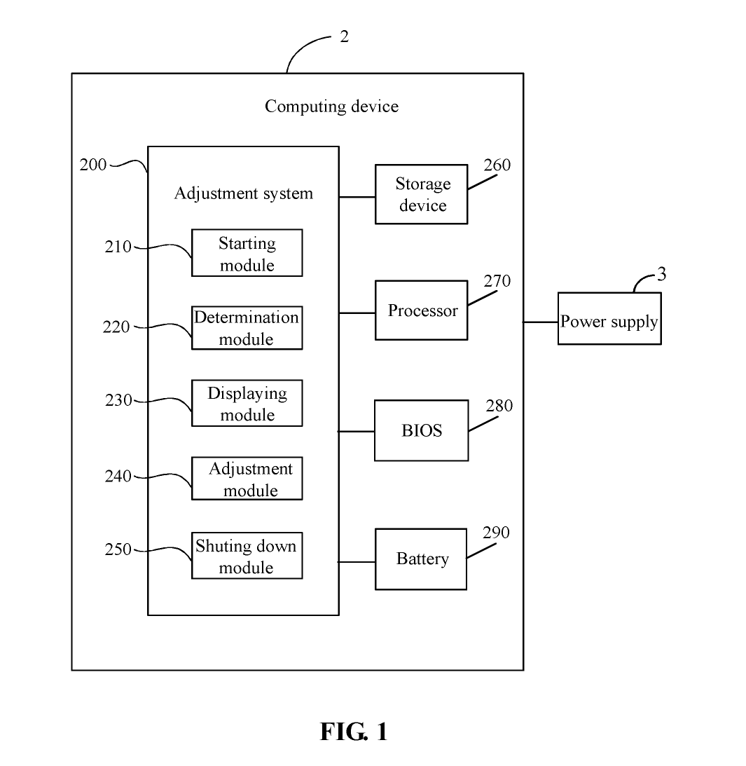

FIG. 1 illustrates a block diagram of an example embodiment of a computing device 2. In the example embodiment, the computing device 2 includes, but is not limited to, an adjustment system 200, a storage device 260, at least one processor 270, a basic input output system (BIOS) 280, and a battery 290. The computing device 2 can be, but is not limited to, a laptop computer or any other portable computing devices. The computing device 2 is connected to a power supply 3, so that the computing device 2 is powered by the power supply 3. The battery 290 is charged by the power supply 2 when the computing device 2 is connected to the power supply 3. The computing device 2 is powered by the battery 290 when the computing device 2 is disconnected to the power supply 3. In addition, the power supply 3 provides alternating current (AC) electricity. The battery 290 provides direct current (DC) electricity. The BIOS 280 determines the electricity which is provided to the computing device 2, so that the BIOS 280 can determine if the computing device 2 is disconnected to the power supply 3 or not. In one embodiment, the BIOS 280 includes an advanced configuration and power interface (ACPI). The BIOS 280 uses the ACPI to detect the electricity which passes through the computing device 2. For example, if the computing device 2 is powered by the DC electricity of the battery 290, the BIOS 280 determines that the computing device 2 is disconnected to the power supply 3. If the computing device 2 is powered by the AC electricity of the power supply 3, the BIOS 280 determines that the computing device 2 is connected to the power supply 3. FIG. 1 illustrates only one example of the computing device 2, and other examples ca comprise more or fewer components that those shown in the embodiment, or have a different configuration of the various components.

In one embodiment, the storage device 260 can be an internal storage device, such as a flash memory, a random access memory (RAM) for temporary storage of information, and/or a read-only memory (ROM) for permanent storage of information. The storage device 260 can also be an external storage device, such as an external hard disk, a storage card, or a data storage medium. The at least one 270 can be a central processing unit (CPU), a microprocessor, or other data processor chip that performs functions of the computing device 2.

The adjustment system 200 comprises, but is not limited to, a starting module 210, a determination module 220, a displaying module 230, an adjustment module 240, and a shutting down module 250. Modules 210-250 ca comprise computerized instructions in the form of one or more computer-readable programs that can be stored in a non-transitory computer-readable medium, for example the storage device 260, and executed by the at least one 270 of the computing device 2. A detailed description of the functions of the modules 210-250 is given below in reference to FIG. 1.

The starting module 210 starts an operating system (OS) of the computing device 2 when the computing device 2 is powered by the AC electricity. In one embodiment, the APCI of the BIOS 280 records electricity information when the computing device 2 is powered on. The electricity information can be, but is not limited to, a specific character or number. For example, if the computing device 2 is powered by the AC electricity, the APCI records the specific character “A” to represent the AC electricity. If the computing device 2 is powered by the DC electricity, the APCI records the specific character “D” to represent the DC electricity. The starting module 210 obtains the electricity information from the APCI of the BIOS 280, and starts the OS of the computing device 2 if the electricity information is the specific character “A.”

The determination module 220 determines if the computing device 2 is powered by the AC electricity or the DC electricity. In one embodiment, if the electricity information stored in APCI of the BIOS 280 is changed from “A” to “D”, the computing device 2 is powered by the DC electricity. That is, the computing device 2 is disconnected to the power supply 3 and powered by the DC electricity of the battery 290.

The determination module 220 further determines a state of the battery 290 if the computing device 2 is powered by the AC electricity or the DC electricity. The state of the battery 290 includes a normal state and a warming state. The normal state is determined upon the condition that a battery level of the battery 290 falls within a first predetermined range of a battery capacity of the batter 290, for example, from 100% of the battery capacity to 20% of the battery capacity. The warming state is determined upon the condition that the battery level of the battery 290 falls within a second predetermined range of the battery capacity of the batter 290, for example, from 20% of the battery capacity to 5% of the battery capacity. In one embodiment, the determination module 220 calculates the battery level of the battery 290 and determines the state of the battery 290 according to the battery level of the battery 290.

The displaying module 230 displays a notification message using the BIOS 290 when the battery 290 is in the normal state. The notification message notifies a user of the computing device to charge the computing device.

The adjustment module 240 adjusts the OS of the computing device 2 to a sleep mode if the battery 290 is in the warming state. The sleep mode is used for power saving of the battery 290. For example, the computing device 2 turns off a displaying device of the computing device 2 and spins down other hard drive of the computing device 2 when the computing device 2 is in the sleep mode.

The starting module 210 activates a watchdog (WDT) of the BIOS 290 to count a predetermined time and saves data into the storage device 260 before the predetermined time ends.

The shutting down module 250 shuts down the OS of the computing device 2 when the predetermined time ends.

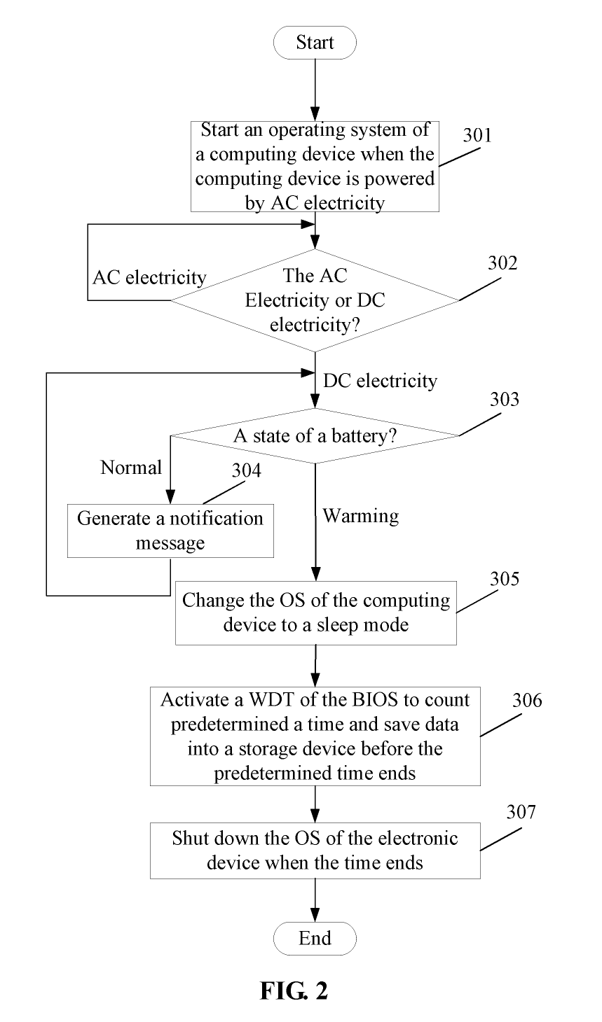

FIG. 2 illustrates a flowchart of an example embodiment of a method for adjusting an operating status of a computing device. In an example embodiment, the method is performed by execution of computer-readable software program codes or instructions by at least one processor of a computing device.

Referring to FIG. 2, a flowchart is presented in accordance with an example embodiment. The method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 2 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

In block 301, a starting module starts an operating system (OS) of the computing device when the computing device is powered by the AC electricity. The starting module obtains the electricity information from the APCI of the BIOS, and starts the OS of the computing device if the electricity information is the specific character “A.”

In block 302, a determination module determines if the computing device is power by the AC electricity or the DC electricity. In one embodiment, if the electricity information stored in APCI of the BIOS is changed from “A” to “D”, the computing device is powered by the DC electricity, the procedure goes to block 303. Otherwise, if the electricity information stored in APCI of the BIOS is still “A”, the computing device is powered by the AC electricity, and the procedure repeatedly executes block 302.

In block 303, the determination module further determines a state of the battery. The state of the battery includes a normal state and a warming state. If the battery is in the normal state, the procedure goes to block 304. Otherwise, if the battery is in the warming state, the procedure goes to block 305.

In block 304, a displaying module displays a notification message using the BIOS when the battery is in the normal state. In one embodiment, the BIOS pops up a dialog box displayed on a display device of the computing device, and displays the notification message (e.g., “please charge the computing device”) on the dialog box.

In block 305, an adjustment module adjusts the OS of the computing device to a sleep mode when the battery is in the warming state. For example, the computing device turns off a displaying device of the computing device and spins down the other hard drive of the computing device, so that the power of the battery is saving.

In block 306, the starting module further activates a watchdog (WDT) of the BIOS to count a predetermined time and saves data of the computing device into the storage device before the predetermined time ends. In one embodiment, the predetermined time (e.g., a minute) is generated and shown in the displaying device of the computing device, so that the user can see the predetermined time. The staring module automatically saves the data which is temporarily stored in the RAM of the computing device into the storage device, so that the data can be stored in the storage device after the computing device is powered down.

In block 307, a shutting down module shuts down the OS of the computing device when the predetermined time ends. In one embodiment, the predetermined time counts down from one minute to zero, the shutting down module shuts down the OS of the computing device.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
at least one processor; and
a storage device that stores one or more programs, which when executed by the at least one processor, cause the at least one processor to:
start an operating system (OS) of the computing device when the computing device is powered by alternating current (AC) electricity of a power supply;
calculate a battery level of a battery of the computing device when the computing device is powered by direct current (DC) electricity of the battery;
determine whether the battery is in a normal state or a warming state according to the battery level of the battery;
adjust the OS of the computing device to a sleep mode when the battery is in the warming state; and
activate a watchdog (WDT) of a basic input output system (BIOS) to count a predetermined time, and save data of the computing device into the storage device before the predetermined time ends.

2. The computing device of claim 1, wherein the at least one processor further generates a notification message using the BIOS when the battery is in the normal state.

3. The computing device of claim 1, wherein the normal state is determined upon the condition that the battery level of the battery falls within a first predetermined range of a battery capacity of the battery.

4. The computing device of claim 1, wherein the at least one processor further shuts down the OS of the computing device when the predetermined time ends.

5. The computing device of claim 1, wherein the warming state is determined upon the condition that the battery level of the battery falls within a second predetermined range of a battery capacity of the battery.

6. A computer-based method for adjusting an operating status of a computing device, the method comprising:
starting an operating system (OS) of the computing device when the computing device is powered by alternating current (AC) electricity of a power supply;
calculating a battery level of a battery of the computing device when the computing device is powered by direct current (DC) electricity of the battery;
determining whether the battery is in a normal state or a warming state according to the battery level of the battery;
adjusting the OS of the computing device to a sleep mode when the battery is in the warming state; and
activating a watchdog (WDT) of a basic input output system (BIOS) to count a predetermined time, and saving data of the computing device into the storage device before the predetermined time ends.

7. The method of claim 6, wherein the notification message is generated by the BIOS when the battery is in the normal state.

8. The method of claim 6, wherein the normal state is determined upon the condition that a battery level of the battery falls within a first predetermined range of a battery capacity of the battery.

9. The method of claim 6, wherein the OS of the computing device is shut down when the predetermined time ends.

10. The method of claim 6, wherein the warming state is determined upon the condition that the battery level of the battery falls within a second predetermined range of the battery capacity of the battery.

11. A non-transitory computer-readable medium having stored thereon instructions that, when executed by at least one processor of a computing device, causing the computing device to perform a method for adjusting an operating status of a computing device, the method comprising:
starting an operating system (OS) of the computing device when the computing device is powered by alternating current (AC) electricity of a power supply;
calculating a battery level of a battery of the computing device when the computing device is powered by direct current (DC) electricity of the battery;
determining whether the battery is in a normal state or a warming state according to the battery level of the battery;
adjusting the OS of the computing device to a sleep mode when the battery is in the warming state; and
activating a watchdog (WDT) of a basic input output system (BIOS) to count a predetermined time, and saving data of the computing device into the storage device before the predetermined time ends.

12. The non-transitory computer-readable medium of claim 11, wherein the notification message is generated by the BIOS when the battery is in a normal state.

13. The non-transitory computer-readable medium of claim 11, wherein the normal state is determined upon the condition that a battery level of the battery falls within a first predetermined range of a battery capacity of the battery.

14. The non-transitory computer-readable medium of claim 11, wherein the OS of the computing device is shut down when the predetermined time ends.

15. The non-transitory computer-readable medium of claim 11, wherein the warming state is determined upon the condition that the battery level of the battery falls within a second predetermined range of the battery capacity of the battery.
